(19) United States
(12) Patent Application Publication
(10) Pub. No.: US 2025/0262585 A1
(43) Pub. Date: Aug. 21, 2025

(54) Duct Rotating Adsorption Machine

(71) Applicant: Howden Group Limited, Scotland (GB)

(72) Inventors: Ryan Mochar, Cumbernauld (GB); Joanne Moore, Falkirk (GB); Dougal Hogg, Glasgow (GB); James Nimmo, Cumbernauld (GB)

(21) Appl. No.: 19/051,614

(22) Filed: Feb. 12, 2025

Related U.S. Application Data
(60) Provisional application No. 63/554,509, filed on Feb. 16, 2024.

(51) Int. Cl. B01D 53/04

(52) U.S. Cl. CPC B01D 53/0407; B01D 2221/00; B01D 2259/4009

(57) ABSTRACT

An adsorption machine includes a stationary matrix of adsorbent elements and a movable duct system. The stationary matrix of adsorbent elements defines channels that extend from a first end of the stationary matrix to a second end of the stationary matrix. The movable duct system includes a first duct portion positioned adjacent the first end of the stationary matrix and a second duct portion positioned adjacent the second end of the stationary matrix. The first duct portion and the second duct portion are configured to move in synchronization with respect to the stationary matrix so that the first duct portion can guide a desorbing flow into the stationary matrix and the second duct portion can guide the desorbing flow, together with any substances desorbed from the stationary matrix, away from the stationary matrix.

### CROSS-REFERENCE TO RELATED APPLICATIONS

This application claims priority to and the benefit of U.S. Provisional Patent Application No. 63/554,509, entitled “DUCT ROTATING ADSORPTION MACHINE,” filed Feb. 16, 2024, which is hereby incorporated by reference in its entirety for all purposes.

### FIELD OF INVENTION

The present invention relates to the field of adsorption machines and, in particular, to industrial adsorption machines adapted to capture specific gasses, elements, and/or particulates, such as carbon dioxide.

### BACKGROUND

Adsorption machines are most often formed as rotary adsorption machines, which are also known as thermal swing adsorption machines, pressure swing adsorption machines, or regenerative rotary separators. These machines are deployed to recover specific gasses, elements, and/or particulates, such as carbon dioxide. More specifically, rotary adsorption machines (RAMs) are often deployed for point source carbon capture and/or for direct air carbon capture. In any case, RAMs typically include an adsorbent material, such as activated carbon, metal-organic frameworks (MOFs) or zeolite (e.g., hydrated aluminosilicates of alkaline and alkaline-earth metals), in a rotatable rotor.

When a process gas, such as a carbon dioxide (CO₂)-laden gas, enters the rotor, the target gasses, elements, and/or particulates (e.g., CO₂) is/are adsorbed onto the adsorbent material. The rotor then rotates the adsorbed substance into a desorption zone to release the target substance from the adsorbent so that the target substance can be captured, processed, or used. The desorption is caused by a change in pressure and/or a change in temperature (e.g., by passing steam through the rotor and/or through electric heating elements). However, large scale RAMs suitable for industrial applications require large rotors which are quite difficult to support, rotate, and seal against. Improved adsorption machines that enable large scale and/or industrial applications are highly desired.

### SUMMARY

The present invention relates to an adsorption machine with a stationary matrix of adsorbent elements (i.e., a stator, as opposed to a rotor) and movable ducts that are configured to cyclically align with different portions of the matrix. For example, the adsorption machine presented herein may include a stationary, cylindrical matrix of adsorbent material and a plurality of rotatable ducts (e.g., hoods). Each of the hoods may define one zone or a plurality of zones. When the hoods define a plurality of zones, the zones may include a desorption zone and a regeneration zone. Additionally, a stationary duct may align with portions of the stationary matrix that are not aligned with the hoods so that these portions are in an adsorption zone when not aligned with the hoods. Thus, the adsorption machine presented herein need not movably support a large, heavy rotor during operation, nor does the adsorption machine presented herein need to seal against a moving rotor that may deflect due its weight and/or thermal expansion effects.

For example, according to the present application, an adsorption machine with a stationary matrix of adsorbent elements and a movable duct system is presented. The stationary matrix of adsorbent elements defines channels that extend from a first end of the stationary matrix to a second end of the stationary matrix. The movable duct system includes a first duct portion positioned adjacent the first end of the stationary matrix and a second duct portion positioned adjacent the second end of the stationary matrix. The first duct portion and the second duct portion are configured to move in synchronization with respect to the stationary matrix so that the first duct portion can guide a desorbing flow into the stationary matrix and the second duct portion can guide the desorbing flow, together with any substances desorbed from the stationary matrix, away from the stationary matrix.

Among other advantages, this adsorption machine may eliminate, or at least reduce, many of the costs and problems associated with rotating a large rotor full of adsorbent material. Rotating a rotor full of adsorbent material is usually difficult and complicated. For example, an industrial RAM may require extensive supports, complex bearings, and may be diameter-limited. Moreover, even with proper support, a rotating matrix of adsorbent materials may experience deformation at its outer ends due to gravitational forces acting on unsupported outer edge of the rotor and/or due to thermal expansion. This is particularly problematic for large, shallow rotors that may be used in a RAM. In turn, the deformation may be a major source of leakage, design complication, and/or seal failure. The adsorption machine presented herein may eliminate, or at least reduce the impact of, these issues.

In some embodiments of the above-described adsorption machine, the stationary matrix is cylindrically shaped, and the first duct portion and the second duct portion are substantially sector shaped. Thus, the duct portions can potentially rotate about a single axis to cover the entire stationary matrix. For example, the movable duct system may be rotatable about a central axis of the stationary matrix, which may be parallel to a direction in which the channels extend. This may save material and costs, balance the rotation, and provide symmetrical heating/wear of the duct portions, e.g., as compared to an eccentric axis that causes portions of the ducts to occasionally overhang (or not fully span) the matrix.

In some embodiments, the movable duct system also includes a third duct portion positioned adjacent the first end of the stationary matrix and a fourth duct portion positioned adjacent the second end of the stationary matrix. The third duct portion and the fourth duct portion are configured to move in synchronization with respect to the stationary matrix so that the third duct portion can guide a portion of the desorbing flow into the stationary matrix and the fourth duct portion can guide the portion of the desorbing flow, together with any substances desorbed from the stationary matrix, away from the stationary matrix. This may make the adsorption machine more efficient, providing two zones of simultaneous desorption that can potentially desorb twice as much target substance from the matrix in a single cycle. In fact, some embodiments may also include fifth and sixth duct portions (i.e., three pairs of ducts) configured in similar fashion. However, the adsorption machine presented herein must be carefully tuned, e.g., based on its size, the environment, and/or the adsorbent material, to provide adequate adsorption in the matrix between exposures to a desorbing flow.

In some embodiments with four duct portions, the third duct portion and the fourth duct portion extend oppositely from the first duct portion and the second duct portion, respectively, so that the third duct portion and the fourth duct portion are disposed across a first half of the stationary matrix when the first duct portion and the second duct portion are disposed across a second half of the stationary matrix. Similarly, in embodiments with six duct portions (e.g., three pairs of ducts), the fifth duct portion and the sixth duct portion may be positioned to extend across a first one-third of the stationary matrix when the first duct portion and the second duct portion are disposed across a second one-third of the stationary matrix and the third duct portion and the fourth duct portion are disposed across a third one-third of the stationary matrix. These positionings can create adequate separation (or potentially maximum separation) between desorbing flows and allow the stationary matrix to adequately adsorb a target substance in between exposures to a desorbing flow (e.g., adsorb a maximum amount of target substance).

Regardless of the number of duct portions, one or more duct portions of the adsorption machine presented herein may include a leading section and a trailing section. The leading section may guide the desorbing flow into and out of the stationary matrix and the trailing section may guide a regenerative flow into and out of the stationary matrix. For example, the leading section may guide a desorbing flow of steam and the trailing section may guide a regenerative flow of conditioning air. While such sections are not required, these sections may enhance the efficiency of the machine, e.g., by allowing the stationary matrix to fully adsorb a target substance when not exposed to a desorbing flow.

According to further embodiments, an adsorption machine including a stationary matrix of adsorbent elements and a movable duct system configured to move incrementally with respect to the stationary matrix is presented herein. The stationary matrix of adsorbent elements defines channels that extend from a first end of the stationary matrix to a second end of the stationary matrix and the movable duct system is configured to dwell in a stationary location between incremental movements. Thus, the movable duct system can form stationary seals against a particular portion of the stationary matrix while guiding a desorbing flow into and out of the particular portion of the stationary matrix. Using stationary seals may vastly improve the effectiveness and wear properties of seals used on the machine, e.g., at least as compared to seals often used in a RAM, which are configured to seal between moving parts.

In some embodiments, the movable duct portion moves seals into contact with the stationary matrix to form the stationary seals during dwell periods. That is, the movable duct portion may move towards the first end and/or second end of the stationary matrix to form a seal there against. Additionally or alternatively, the movable duct portion and/or the matrix may include expandable seals that expand between the stationary matrix and the movable duct system to form the stationary seals during dwell periods.

Either way, the seals will only need to seal between stationary surfaces, which allows the absorption machine to use longer lasting seals that are also less expensive (e.g., over time and/or due to material costs). This is especially important in an adsorption machine where sealing is paramount to efficiency of the machine (and without efficiency, the machine may not be operational). Additionally, sealing between static structures may allow longer seals to be used at least because a continuous seal can be used to wrap around corners (e.g., of a matrix sector and/or duct portion). This may eliminate leakage that might occur at seal interfaces. Longer seals, whether enabled by cost efficiencies, static sealing, and/or another factor may, in turn, allow the width (e.g., the dimension perpendicular to the general direction in which the channels extend) of the matrix to increase, e.g., to provide a wide, but shallow adsorbent matrix. In view of the foregoing, the adsorbent machine presented herein may be more efficient and effective.

Still further, in some embodiments, incremental movements are indexed to move the first duct portion and the second duct portion from a first portion of the stationary matrix to a second portion of the stationary matrix that is adjacent to, but non-overlapping with, the first portion. For example, the stationary matrix may be cylindrically shaped and subdivided into sector portions, including the first portion and the second portion, that have equal sizes. Meanwhile, the first duct portion and the second duct portion may be sector-shaped and sized to match the sector portions of the stationary matrix. Then, the indexed incremental movement may move the sector-shaped duct portions from one sector to another equally sized sector.

Indexed motion between non-overlapping locations may ensure that the duct system guides a desorbing flow to only parts of the matrix that have not been exposed to the desorbing flow in the immediately prior dwell location. Thus, this type of indexed motion will not “waste” desorbing flow in an inefficient manner. Moreover, providing equally sized sectors will cause the indexed movement to be constant over time, which creates known sealing points that can be monitored and serviced over time (and/or specially structured). However, to be clear, indexed movement need not be limited to embodiments where the matrix is divided into equally sized portions, and other such embodiments may still realize other advantages of indexing (e.g., efficiency gains). For example, some embodiments may include a square stationary matrix with an indexing rectangular duct system that translates across the stationary matrix. In this embodiment, the rectangular duct system may have an adsorbing flow duct flanked by two desorbing flow ducts that move ahead of, and behind, the adsorbing flow to ensure the adsorbing material is adequately prepared regardless of the direction of uniform indexing of the adsorbing flow duct.

According to still other embodiments, the present application is directed to a method of adsorption. The method includes providing a stationary matrix of adsorbent elements defining channels that extend from a first end of the stationary matrix to a second end of the stationary matrix. A duct system is positioned to extend over a portion of the stationary matrix, and the duct system is configured such that when the duct system dwells in a stationary location. The duct system forms stationary seals against the portion of the stationary matrix while guiding a desorbing flow into and out of the portion of the stationary matrix. The duct system is then incrementally moved with respect to the stationary matrix, from the portion of the stationary matrix to a next portion of the stationary matrix. This method may also incorporate any features of the adsorbent machines described above and realize any advantages thereof.

The present application may also be directed to additional apparatuses, systems, and/or methods. Additionally or alternatively, other advantages and features will become evident in view of the drawings and detailed description.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is a schematic view of a combined cycle power plant with an adsorption machine formed in accordance with an example embodiment of the present application.

FIG. 2 is a top, front perspective view of a prior art RAM.

FIG. 3 is a schematic illustration of thermal effects that may impact the prior art RAM of FIG. 2.

FIG. 4 is a schematic illustration of an adsorption machine formed in accordance with an embodiment of the present application.

FIG. 5 is a schematic, partial sectional view of the adsorption machine of FIG. 4.

FIG. 6 is a schematic illustration of a stationary matrix included in the adsorption machine of FIG. 4.

FIG. 7 is a schematic illustration of a movable duct portion that may be included in the adsorption machine of FIG. 4.

FIGS. 8A and 8B are schematic illustrations of a technique of forming a seal between a duct portion and the stationary matrix of the adsorption machine of FIG. 4, in accordance with a first embodiment of the present application.

FIGS. 9A and 9B are schematic illustrations of a technique of forming a seal between a duct portion and the stationary matrix of the adsorption machine of FIG. 4, in accordance with a second embodiment of the present application.

FIG. 10 schematically illustrates a plan view of the adsorption machine of FIG. 4.

FIG. 11 schematically illustrates a plan view of a variation of the adsorption machine of FIG. 4, formed in accordance with an embodiment of the present application.

FIG. 12 schematically illustrates a sectional view of a variation of the adsorption machine of FIG. 4, formed in accordance with an embodiment of the present application.

FIG. 13 is a flow chart illustrating a method of adsorption according to an embodiment of the present application.

Like numerals have been used throughout the Figures.

### DETAILED DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Generally, this application is directed to a rotary-type adsorption machine (which, for simplicity, is often referred to herein simply as an “adsorption machine”). However, the adsorption machine presented herein rotates its ducts, either continuously or discontinuously; the adsorption machine does not utilize a rotating matrix of adsorbent material. Such a machine will be particularly useful for large scale (e.g., industrial) carbon capture applications, for which designs, to date, have been largely unsuccessful due to temperature, pressure, and force distribution problems, among other issues. In fact, these issues only become exacerbated as the size of the adsorption machine increases. The adsorption machine presented herein resolves these issues by utilizing a static absorbent matrix and/or by incrementing movement of the ducts that move with respect to the matrix.

That is, the present application provides an adsorption machine with a stationary matrix of adsorbent elements (i.e., a stator instead of a rotor) and movable ducts that are configured to cyclically align with different portions of the matrix. For example, the adsorption machine presented herein may include a stationary, cylindrical matrix of adsorbent material and a plurality of rotatable duct portions or hoods. Each of the duct portions/hoods may define one zone or a plurality of zones. When the hoods define a plurality of zones, the zones may include a desorption zone and a regeneration zone. Additionally, a stationary duct may align with portions of the stationary matrix that are not aligned with the hoods so that these portions are in an adsorption zone when not aligned with the hoods. Thus, the adsorption machine presented herein need not movably support a large, heavy rotor during operation, nor does the adsorption machine presented herein need to seal against a moving rotor that may deflect due its weight and/or thermal expansion effects.

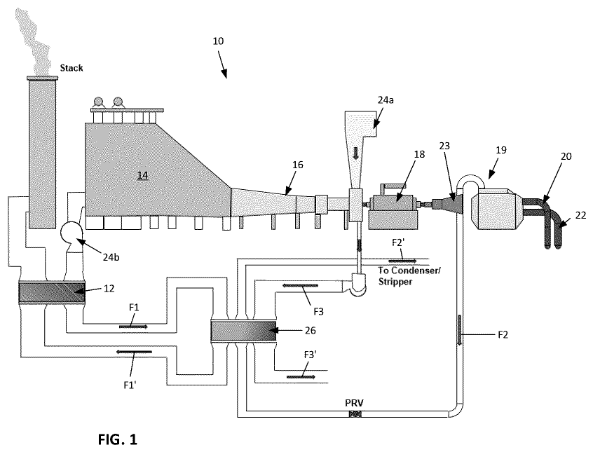

An example power plant 10 of a type that may incorporate an adsorption machine 26 formed in accordance with the present application is illustrated in FIG. 1. However, to be clear, the power plant 10 of FIG. 1 is merely an example and, in other embodiments, adsorption machine 26 may be positioned in any desirable location, e.g., for carbon capture. For example, power plant 10 generally depicts a combined cycle gas turbine (CCGT) power plant, but the adsorption machine 26 could also be positioned/included in a conventional coal powered power plant or any other flue system (e.g., for point source capture). In fact, it is envisioned that the adsorption machine 26 presented herein may be configured to capture carbon dioxide from ambient air or for any other type of gas separation (e.g., by tuning the adsorbent for a specific gas species, such as methane). For example, the adsorption machine 26 presented herein may be positioned in locations in which CO₂-laden gas entering the adsorption machine 26 is ambient air (as opposed to a process effluent).

That said, in FIG. 1, the power plant 10 includes a gas turbine 16, a Heat Recovery Steam Generator (HRSG) 14 coupled with a steam turbine 23. Turbines 16 and 23 combine to drive the generator 18 to produce electricity. The steam turbine 23 is connected to a condenser 19 with an intake 20 and exhaust 22. The power plant 10 also includes fans 24a and 24b, which may be used to move air through this system. Meanwhile, a heat exchanger 12 may be positioned adjacent the exhaust of the HRSG 14. Although not shown, a power plant utilizing the adsorption machine 26 might also include another heat exchanger to heat the air entering a boiler. For example, such a heat exchanger might heat air entering a boiler with heat from combustion gases expelled from the boiler (while also cooling the gas expelled from the boiler).

In the arrangement of FIG. 1, cooled exhaust gas enters the adsorption machine 26 as a first fluid flow F1. However, to reiterate, exhaust gas is merely one example of gas that may enter the adsorption machine 26 as first fluid flow F1. As other examples, the first fluid flow F1 may be a flow of ambient air and/atmosphere, or a combination of ambient air/atmosphere and an exhaust gas. In any case, when the first fluid flow F1 encounters adsorptive elements included in the adsorption machine 26, the adsorptive elements can adsorb a specific portion of the first fluid flow F1 (e.g., carbon dioxide). Then, the adsorptive elements can retain the adsorbed portion of the first fluid flow F1 until exposed to a desorbing flow. Meanwhile, a portion of the first fluid flow F1 that is not captured by the adsorptive elements may exit the adsorption machine 26 as process flow F1′, e.g., to (or back to) atmosphere, e.g., by way of heat exchanger 12 where it can be used to cool exhaust gas. Additionally or alternatively, the process flow F1′ could be fed to a conduit that directs the process flow F1′ to a downstream processing operation that require clean gas/air.

In FIG. 1, a second fluid flow F2 is also directed into the adsorption machine 26 to cause the adsorptive elements carrying the adsorbed portion of the first fluid flow F1 to desorb the adsorbed portion of the first fluid flow F1. For example, steam may be directed into the adsorption machine 26 as the second fluid flow F2 to create a temperature change that releases carbon dioxide from adsorptive elements for carbon capture. To illustrate this example, the steam of the second fluid flow F2 emanates from steam turbine operations (e.g., from condenser 19) in FIG. 1. However, regardless of how the second fluid flow F2 is generated, passing the second fluid flow F2 through the adsorption machine 26 produces a fluid flow F2′, which exits the adsorption machine 26 and may carry carbon dioxide and may be directed to a storage tank, condenser, and/or stripper, e.g., to prevent the carbon dioxide from entering or re-entering the atmosphere (e.g., to remove carbon dioxide from the atmosphere).

After adsorptive elements desorb the adsorbed portion of the first fluid flow F1 (e.g., carbon dioxide), the adsorptive elements may be exposed to a regenerative flow, such as a flow of conditioning air (e.g., driven by fan 24a). The regenerative flow enters adsorption machine 26 as a regenerative fluid flow F3 and exits the adsorption machine 26 as a fluid flow F3′ (which, may, in some instances, combine with the process flow F1′ on exiting the adsorption machine 26, as shown in FIG. 1). This regenerative fluid flow F3 prepares the adsorptive elements to adsorb a target substance (e.g., by cooling the adsorptive elements). However, other embodiments might not need/use a regenerative fluid flow F3.

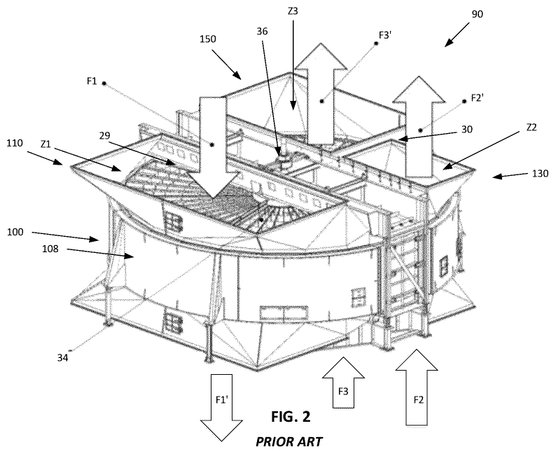

As a point of comparison for the adsorption machine presented herein, FIG. 2 illustrates a top perspective view of a prior art rotary adsorption machine (RAM) 90 that might be adopted as adsorption machine 26. RAM 90 includes a rotor 34 that is rotatable within a housing 100. Thus, the housing 100 must be specifically designed to enclose and seal against portions of the rotor 34 to help dictate how and where fluid (e.g., gas) will enter, exit, or move with the rotor 34. These design considerations become more important and more difficult to manage if the RAM 90 is to be large enough to be suitable for large scale (e.g., industrial) operations, e.g., operations that require a rotor 34 with a diameter equal to or greater than 20 meters, such as 24 meters.

More specifically, with a RAM 90, the rotor 34 is configured to continuously rotate around a central hub 36 to move radially aligned adsorbent elements through a cycle of zones (e.g., through zones Z1, Z2, and Z3). During this rotation, the housing 100 circumferentially retains gas in the rotor 34 and creates pathways along which fluid can axially enter or exit the rotor 34. The circumferential retention is achieved by closely positioning a cylindrical section 108 of the housing 100 against an outer shell of the rotor 34 and/or with sector plate assemblies 29 and 30. Then, axial seal plates, axial seals, and/or circumferential seals may be positioned between the rotor 34 and the outer shell of rotor 34 to prevent or minimize leakage therebetween (e.g., leaf seals, contact seals, etc.). Additionally, seals must be formed between moving parts, e.g., with seals extending away from rotor 34 that intermittently engage different sector assemblies 29 and 30 and/or with seals extending away from sector assemblies 29 and 30 that engage each successive radial plate of rotor 34.

In the depicted prior art embodiment, the RAM 90 includes three stationary ducts that are generally aligned with zones Z1, Z2, and Z3: (1) a first stationary duct 110 generally aligned with adsorption zone Z1; (2) a second stationary duct 130 generally aligned with desorption zone Z2; and (3) a third stationary duct 150 generally aligned with the regeneration zone Z3. The first fluid flow F1 (e.g., ambient air) generally flows in a first longitudinal direction (e.g., downwards) while fluid flows F2 and F3 (a desorbing flow and regenerative flow, respectively) generally flow in an opposite longitudinal direction (e.g., upwards).

As can be seen, a first sector assembly 29 separates the first zone Z1 (generally aligned with first stationary duct 110) from both the second zone Z2 (generally aligned with second stationary duct 130) and the third zone Z3 (generally aligned with third stationary duct 150). Additionally, a second sector assembly 30 separates the second zone Z2 from the third zone Z3. Thus, during rotation, the adsorbent elements in the rotor 34 move in or out of the first zone Z1 (e.g., from third zone Z3 or to second zone Z2) by passing through sector assembly 29. Meanwhile, the adsorbent elements in the rotor 34 move from the second zone Z2 to the third zone Z3 by passing through sector assembly 30. However, in other instances, one or more sector assemblies can delineate any number of sectors in the annular space between the central hub 36 of rotor 34 and the cylindrical section 108 of housing 100 (e.g., for a tri-sector, quad-sector, etc. RAM).

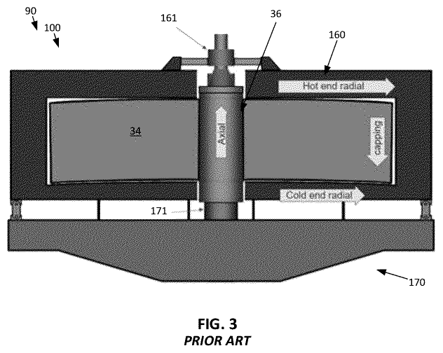

Still referring to FIG. 2, but now in combination with FIG. 3, since the rotor 34 moves adsorbent elements between zones Z1, Z2, and Z3, the zones must be separated by sealing between the moving rotor and sector assemblies 29 and 30. Thus, as mentioned above, seals must be formed between sector assemblies 29 and 30 and moving radial plates of rotor 34. These seals have been found to require complicated, expensive constructions and/or to wear down quickly. In view of this, some RAMs 90 also include sector assemblies 29 and 30 that are each supported, at least in part, by a top frame assembly 160 and bottom frame assembly 170 that are carefully designed to support, perhaps movably, sector assemblies 29 and 30. At the same time, frame assemblies 160 and 170 must support bearings, such as top bearing 161 and bottom bearing 171 that allow the rotor 34 to continuously rotate (see FIG. 3). These bearings are often quite complicated, and access is required for routine maintenance. Bearings access platforms may reduce the area of the rotor 34 open to flow.

More specifically, and now turning specifically to FIG. 3, which depicts a side, schematic view of the rotor 34 rotating through the housing 100, during rotation of rotor 34, ends of the rotor 34 may experience deformation. Deformation may be driven by gravitational forces and/or by thermal expansion. Thermal expansion occurs because opposite ends of rotor 34 (e.g., a top and bottom of rotor 34) are subjected to opposite temperature extremes. This subjects the rotor 34 to differential expansion that causes parabolic deformation towards cold temperatures, often referred to as “rotor turndown” (e.g., towards the bottom of the adsorption machine 26). Deformation of the rotor 34, particularly at the outermost ends, creates significant running gaps between a top of the rotor 34 and a top sector plate disposed at a bottom of the top frame assembly 160 (e.g., hot end radial leakage). These running gaps may allow for significant leakage between the various zones of the adsorption machine 26 (e.g., the adsorption zone Z1, the desorption zone Z2, and the regeneration zone Z3), which may be referred to as radial seal leakage.

Additionally or alternatively, rotor deformation may allow for radial seal leakage (e.g., cold end radial leakage) between the rotor 34 and a bottom sector plate supported by frame assembly 170. Still further, rotor deformation may lead to axial seal leakage between the rotor 34 and the sides of a sector assembly (e.g., proximate cylindrical section 108), circular seal leakage between the outer shell of the rotor 34 and the cylindrical section 108 of the housing 100, entrained leakage of the rotor 34, and/or cause friction during rotation of the rotor 34. Thus, RAMs like RAM 90 must incorporate features or elements that account for rotor deformation, e.g., to allow the two or more sector plate assemblies to create seals between the plurality of zones (e.g., zones Z1, Z2, and Z3). Such features can often be complicated, expensive, and/or difficult to maintain.

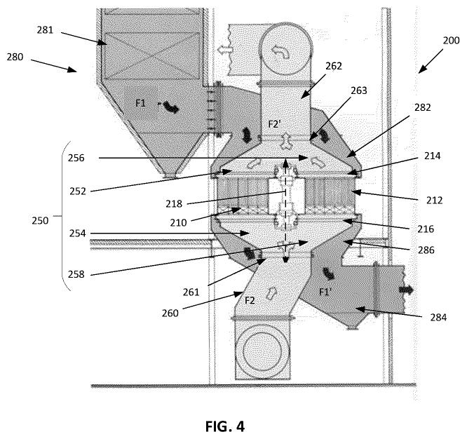

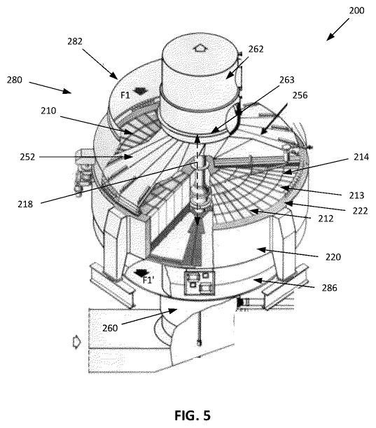

Now turning to FIGS. 4-5, the adsorption machine 200 presented herein includes a stationary matrix 210 and a movable duct system 250 instead of a rotatable rotor (e.g., instead of rotor 34). The movable duct system 250 moves with respect to the stationary matrix 210 to cycle adsorbent elements 212 in the stationary matrix 210 through adsorbing cycles (e.g., repeatedly adsorbing and desorbing). In the depicted embodiment, the movable duct system 250 includes movable duct portions disposed within a stationary duct system 280.

The stationary duct system 280 generally guides a first fluid flow F1 to the adsorbent elements 212 so that the adsorbent elements 212 can adsorb a specific portion of the first fluid flow F1 (e.g., carbon dioxide). Meanwhile, the movable duct system 250 moves into alignment with different portions of the stationary matrix 210 to selectively and cyclically guide a desorbing flow F2 towards different portions of the stationary matrix 210. Thus, over time, the movable duct system 250 captures a specific substance via interactions with the stationary matrix 210. In other words, at a high-level, the adsorption machine 200 utilizes the operating principles of an adsorption machine described above in connection with FIGS. 1 and 2, but now does so in an efficient and effective manner.

In the depicted embodiment, the stationary matrix 210 is a cylindrical structure centered around a longitudinal axis 218 and bounded by an outer shell 220. The stationary matrix 210 (which may also be referred to as a stator) extends along its longitudinal axis 218, from a first end 214 to a second end 216. The cylindrical, stationary matrix 210 is also horizontally oriented so that the first end 214 is a top surface of the cylinder and the second end 216 is a bottom surface of the cylinder. However, in other embodiments, the stationary matrix 210 may be shaped or oriented differently. For example, the stationary matrix 210 may be cylindrically-shaped, but vertically oriented, with the first end 214 and second end 216 defining left and right sides of the stationary matrix 210. Regardless, the adsorbent elements 212 generally define channels 213 (see FIG. 5) that extend through the stationary matrix 210 in a direction that is generally parallel to the longitudinal axis 218. To be clear, “generally parallel” may mean that a general extension direction of channels 213 (which can be skewed, irregular, snaked, twisted, wavy, etc. while still generally spanning from one end to another end) is parallel to the longitudinal axis 218.

As can be seen in FIGS. 4 and 5, the adsorbent elements 212 of the depicted embodiment are generally organized around the longitudinal axis 218. In some instances, adsorbent elements 212 may be grouped into sector-shaped containers that are coupled together to form the stationary matrix 210 and/or installed in a chassis of the stationary matrix 210. Additionally or alternatively, the stationary matrix 210 may include additional plates to subdivide containers and/or the chassis (extending radially, circumferentially, or in any other direction). In any case, adsorbent elements 212 (e.g., structures including adsorbent material) may be stored and/or installed within stationary matrix 210. For example, adsorbent elements 212 may be “dropped down” into containers to fill stationary matrix 210 with adsorbent material. Moreover, regardless of how the stationary matrix 210 is formed or constructed, the adsorbent may be formed from any adsorbent now known or developed hereafter that is suitable for adsorbing carbon dioxide, such as activated carbon, MOFs, zeolite(s), or combinations thereof.

Critically, the stationary matrix 210 does not move during operations of the adsorption machine 200. That is, the stationary matrix 210 does not move or rotate around a central hub arranged coaxially with its longitudinal axis 218. Thus, the stationary matrix 210 requires minimal structural support, does not require large, complicated bearings, and need not seal against a housing that circumferentially surrounds the stationary matrix 210. Instead, the outer shell 220 of the stationary matrix 210 may be the outer boundary of the stationary matrix 210 and may serve as a flow boundary for flows entering and exiting the stationary matrix 210.

Instead, the movable duct system 250 rotates with respect to the stationary matrix 210. More specifically, in the depicted embodiment, the movable duct system 250 includes four movable (e.g., rotatable) duct portions 252, 254, 256, and 258 that rotate with respect to the stationary matrix 210 and with respect to stationary ducts. The first duct portion 252 and the third duct portion 256 are disposed between a stationary duct portion 262 and the first end 214 of the stationary matrix 210 (e.g., above the stationary matrix 210). Thus, the only points of sealing for these duct portions may be: (1) a rotational joint 263 between the stationary duct portion 262 and duct portions 252 and 256; and (2) gaps between outer edges of duct portions 252 and 256 and the stationary matrix 210. The former seal may be achieved with seals for rotational joints now known or developed hereafter and the latter seal(s) may be achieved in a variety of manners that are discussed further below.

Meanwhile, the second duct portion 254 and the fourth duct portion 258 are disposed between a stationary duct portion 260 and the second end 216 of the stationary matrix 210 (e.g., below the stationary matrix 210). Thus, the only points of sealing may be: (1) a rotational joint 261 between the stationary duct portion 260 and duct portions 254 and 258; and (2) gaps between outer edges of duct portions 254 and 258 and the stationary matrix 210. Again, the former seal may be achieved with seals for rotational joints now known or developed hereafter and the latter seal(s) may be achieved in a variety of manners discussed below.

To be clear, the first duct portion 252 and the third duct portion 256 do not necessarily need to be formed together or otherwise tied together. Instead, ducts of the movable duct system 250 may be generally tied to corresponding ducts disposed on an opposite end of the stationary matrix 210. For example, in the depicted embodiment, the first duct portion 252 and the second duct portion 254 may be longitudinally aligned with each other and may be configured to travel in synchronization with each other (although “aligned” and “synchronization” should not be understood to require perfect alignment or coordination, respectively). Meanwhile, the third duct portion 256 and the fourth duct portion 258 are longitudinally aligned with each other and are configured to travel in synchronization with each other. Thus, when the movable duct system 250 directs a second fluid flow F2 to the stationary matrix 210, pairs of ducts can guide the second fluid flow F2 (i.e., the desorbing flow) into and out of stationary matrix 210.

Furthermore, while the depicted embodiment generally depicts the second fluid flow F2 moving upwards (e.g., from the second end 216 to the first end 214 of the stationary matrix 210), the second fluid flow F2 may flow an opposite direction in other embodiments. Thus, in some instances, the first duct portion 252 and the third duct portion 256 direct the second fluid flow F2 (i.e., the desorbing flow) into the stationary matrix 210. Then, after the second fluid flow F2 causes the adsorbent elements 212 to desorb target substances, the second duct portion 254 and the fourth duct portions 258 may direct a fluid flow F2′, which includes at least a portion of second fluid flow F2 and any substances (e.g., carbon dioxide) desorbed from the adsorbent elements 212, out of the stationary matrix 210. However, in other instances, the opposite may be true (i.e., the flows may move as depicted in FIG. 4 and the movable duct portions may perform opposite roles). In any case, the fluid flow F2′ exiting adsorption machine 200 may carry carbon dioxide and may be directed to a storage tank, condenser, and/or stripper, e.g., to prevent the carbon dioxide from entering or re-entering the atmosphere (e.g., to remove carbon dioxide from the atmosphere).

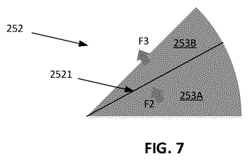

Moreover, in some embodiments, the movable duct system 250 may also direct a third fluid flow F3 (not shown in FIGS. 4 and 5) into and out of the stationary matrix 210. The third fluid flow F3 may be a regenerative flow that prepares adsorbent elements 212 which recently desorbed a substance to adsorb additional target substance. One example arrangement for introducing a regenerative flow via duct portions 252, 254, 256, and 258 is described in further detail in connection with FIG. 7 below.

Regardless of the flows guided by movable duct system 250 and/or the direction in which such flows are guided, the movable duct system 250 is generally rotatable with respect to a stationary duct system 280 (in addition to the stationary matrix 210). At a high-level, the stationary duct system 280 may be configured to direct the first fluid flow F1 to at least some portions of the stationary matrix 210 not aligned with the movable duct system 250. In the depicted embodiment, the stationary duct system 280 does so by covering the entire stationary matrix 210 and the movable duct system 250. That is, the stationary duct system 280 is aligned with an outer shell 220 of stationary matrix 210, and the movable duct system 250 is disposed within the stationary duct system 280. Thus, the movable duct system 250 can selectively block the stationary duct system 280 from guiding the first fluid flow F1 to certain portions of the stationary matrix 210.

More specifically, the stationary duct system 280 includes a first duct portion 281 that is fluidly coupled to a first hood 282 and a second duct portion 284 that is fluidly coupled to a second hood 286. The first hood 282 covers the first end 214 of the stationary matrix 210 and the second hood 286 covers the second end 216 of the stationary matrix 210. Thus, one hood of hoods 282 and 286 will guide a first fluid flow F1 into the stationary duct system 280 at any locations of the stationary matrix 210 not covered by the movable duct system 250 and the other hood of hoods 282 and 286 will guide a portion of the first fluid flow F1 that is not captured by the adsorbent elements 212 to exit the adsorption machine 200 as process flow F1′. For example, the stationary duct system 280 may direct the process flow F1′ to (or back to) atmosphere (perhaps by way of additional elements). Additionally or alternatively, the process flow F1′ could be fed to a conduit that directs the process flow F1′ to a downstream processing operation that requires clean gas/air. In the depicted embodiment, the first fluid flow F1 moves generally downwards (e.g., from the first end 214 to the second end 216 of the stationary matrix 210); the first fluid flow F1 may flow an opposite direction in other embodiments.

Still referring to FIGS. 4 and 5, in the depicted embodiment, each of the duct portions 252, 254, 256, and 258 is generally sector-shaped such that it can extend from the longitudinal axis 218 of the stationary matrix 210 to the outer shell 220 of the stationary matrix 210. In fact, a first or inner end each of the duct portions 252, 254, 256, and 258 may be coupled to a drive shaft that is substantially coaxial with longitudinal axis 218, and at least a portion of a second or outer end of each of the duct portions 252, 254, 256, and 258 may sit atop a longitudinal surface 222 of the outer shell 220 of the stationary matrix 210.

Notably, while FIG. 5 only shows a top, longitudinal surface 222 of the outer shell 220, this surface is representative of top and bottom longitudinal surfaces with which the duct portions may engage, whether disposed adjacent the first end 214 or second end 216 of the stationary matrix 210. The duct portions 252, 254, 256, and 258 may each engage this surface in any desirable manner that allows sliding, rolling, moving, etc. of the duct portions 252, 254, 256, and 258 with respect to the stationary matrix 210 (i.e., any manner of movable engagement now known or developed hereafter). In fact, ducts on a bottom side (e.g., second end 216) of stationary matrix 210 may include engagement mechanisms to ensure that such ducts remain coupled to the stationary matrix 210 during movement of such ducts around the stationary matrix 210. That all said, in some embodiments, duct portions 252, 254, 256, and 258 may not directly engage the stationary matrix 210 during movement of the duct portions 252, 254, 256, and 258 with respect to the stationary matrix 210. That is, duct portions 252, 254, 256, and 258 may be spaced from the stationary matrix 210 (e.g., from the longitudinal surface 222 of outer shell 220) by a gap during movement of the duct portions 252, 254, 256, and 258 with respect to the stationary matrix 210.

Moreover, in other embodiments, the stationary matrix 210 and/or the duct portions 252, 254, 256, and 258 may have any shape and/or configuration. For example, the stationary matrix 210 may be ovular, stadium-shaped, square, rectangular, etc. and the duct portions may traverse portions of the stationary matrix 210 in any desirable manner. Additionally or alternatively, an adsorption machine 200 formed in accordance with the present application need not include two pairs of duct portions; instead, an adsorption machine 200 can include one pair of movable duct portions or three or more pairs of movable duct portions. Still further, an adsorption machine might not include pairs of two duct portions and, for example, might include two inlet duct portions and one outlet duct portion or other such variations.

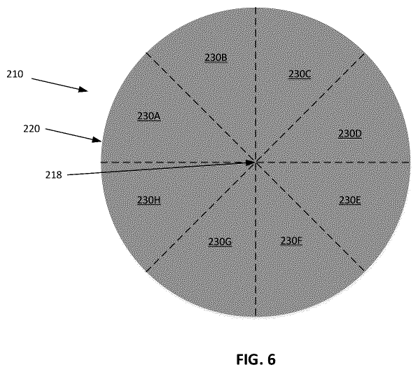

Now turning to FIG. 6, in at least some embodiments of the present application, the adsorption machine 200 may include movable duct system 250 that moves incrementally (i.e., non-continuously). Thus, the movable duct system 250 may position movable ducts over a specific portion or sector of a stationary matrix 210 for a dwell period, move the movable duct portions to a next portion or sector after the dwell period, and repeat. As an example, FIG. 6 schematically depicts a stationary matrix 210 with geometric lines superimposed thereon to delineate sectors 230A-230H. In this example, the stationary matrix 210 includes eight equally sized and non-overlapping sectors 230A-230H. Thus, one or more pairs of movable ducts could be positioned over one sector and incrementally move from one sector to an adjacent sector after a dwell period. That is, the movable ducts could be indexed to move from one sector to another during each incremental movement. The indexing may be achieved with any mechanical, electrical, and/or computing mechanisms now known or developed hereafter.

Indexing movements of sector-sized movable ducts over equally sized sectors 230A-230H will cause the sealing locations between the movable ducts and stationary matrix 210 to be constant over time: the edges of sectors 230A-230H would always be the sealing locations. Thus, these locations can be specifically designed for sealing, monitored over time, or periodically serviced. However, indexed movement could also be used when the sectors are non-equal and/or when the movable ducts are not sized to match the sectors. For example, if a movable duct portion spans 50 degrees, seven indexed rotations of fifty degrees would rotate the movable duct through 350 degrees and would not align the movable duct in its original location. Nevertheless, the movable duct can incrementally move as such. Alternatively, the movable duct could be re-aligned after a predetermined number of rotations to limit the location in which the movable duct will seal.

FIG. 7 schematically illustrates movable duct portion 252 subdivided into a leading section 253A and a trailing section 253B. However, this schematic illustration should not be limited to only movable duct portion 252 and should be understood to be representative of modifications that can be made to any desirable duct portion of the adsorption machine 200 presented herein. However, to be clear, this arrangement is optional and, in some instances, the adsorption machine 200 may operate without a regenerative fluid flow F3. In such instances, the stationary matrix 210 may naturally “regenerate” as it is exposed to process fluid F1′.

In this example, duct portion 252 is split by a partition 2521. The partition 2521 creates a leading section 253A that will be ahead of the trailing section 253B along the direction of rotation of the duct portion 252 (e.g., during clockwise rotation). Thus, the leading section 253A can guide a desorbing flow F2 to the stationary matrix 210 and the trailing section can guide a regenerative fluid flow F3 to a portion of the stationary matrix 210 that has recently been exposed to a desorbing flow. In instances where rotation moves the duct portion 252 in an opposite direction of rotation (e.g., counterclockwise rotation), the sections could be flipped or flow routing to the sections could be reconfigured. Either way, a conduit for the regenerative fluid flow F3 may be run inside or alongside the movable duct system 250 to keep the regenerative fluid flow F3 separate from the desorbing flow F2.

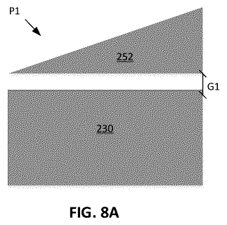

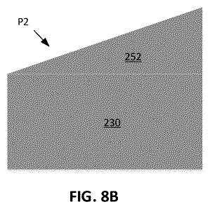

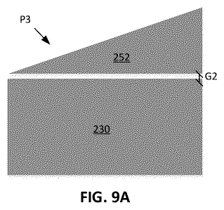

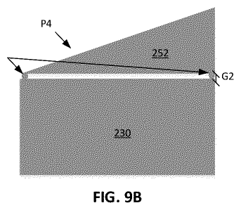

Now turning to FIGS. 8A, 8B, 9A, and 9B, these Figures illustrate exemplary manners in which movable duct portions may seal against the stationary matrix 210. Again, these schematic illustrations show duct portion 252, but should not be limited to only movable duct portion 252. Instead, these illustrations should be understood to be representative of modifications that can be made to any desirable duct portion of the adsorption machine 200 presented herein.

In FIGS. 8A and 8B, the movable duct portions move longitudinally to close a gap G1 between the duct portion and the stationary matrix 210. Thus, stationary seals included on movable duct portion 252 and/or stationary matrix 210 can seal between these two parts, e.g., during a dwell period of the duct portion 252. That is, after moving incrementally along a surface of the stationary matrix 210 with a gap G1 between the duct portion 252 and the stationary matrix 210 (as demonstrated by position P1), a duct portion 252 may move longitudinally towards the stationary matrix 210 to close the gap G1 and seal thereagainst (as shown by position P2). Advantageously, stationary seals that seal between stationary structures may last longer and be less expensive to manufacture and maintain than movable seals or seals that seal between moving parts.

In FIGS. 9A and 9B, the movable duct portions include expandable seals 290 that can move longitudinally to contact the stationary matrix 210. Thus, after moving incrementally along a surface of the stationary matrix 210 with a gap G2 between the duct portion 252 and the stationary matrix 210 (as demonstrated by position P3), the expandable seals 290 may expand longitudinally towards the stationary matrix 210 to close the gap G2 and seal thereagainst (as shown by position P4). However, in other embodiments, the expandable seals 290 need not be included exclusively on the movable duct portion 252. Instead, some or all of the expandable seals 290 might be included on the stationary matrix 210. Expandable seals 290 disposed on the stationary matrix 210 would expand towards the duct portion 252 during a dwell period. In any case, these expandable seals 290 will achieve advantages associated with sealing between stationary structures.

Moreover, to be clear, the options shown in FIGS. 8A-B and 9A-B are not mutually exclusive; some embodiments may include expandable seals and longitudinally movable duct portions. These embodiments are also not only usable with adsorption machines that move duct systems incrementally; the sealing systems might also be usable with a duct system that moves continuously with respect to a stationary matrix (e.g., to seal during periods of slower movement and unseal during periods of faster movement).

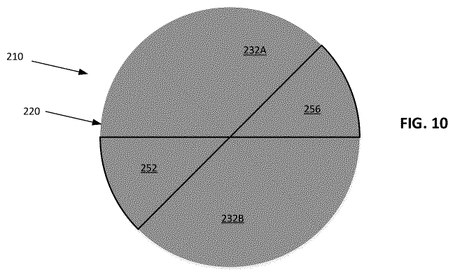

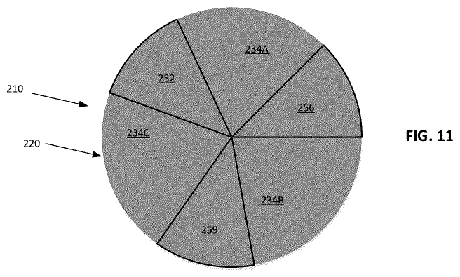

FIGS. 10 and 11 further demonstrate exemplary options for arranging duct portions of a movable duct system. In FIG. 10, two duct pairings (represented by duct portions 252 and 256, respectively) are arranged to extend oppositely from each other. Thus, when one duct pairing (e.g., the duct pairing represented by duct portion 252) is on a first half 232B of the stationary matrix 210, the other duct pairing (e.g., the duct pairing represented by duct portion 256) is on a second, opposite half 232A of the stationary matrix 210. Such positioning may ensure that adsorbent elements 212 in the stationary matrix 210 have a maximum amount of time to adsorb a target substance between exposures to a desorbing flow emanating from a duct pairing. The duct pairings could move in synchronization through respective halves 232A and 232B or could move in different manners through respective halves 232A and 232B (while still maintaining general spacing).

Similarly, in FIG. 11, three duct pairings (represented by duct portions 252, 256, and 259 respectively) are arranged to be equally spaced from each other. Thus, when one duct pairing (e.g., the duct pairing represented by duct portion 252) is aligned with a first one-third 234C of the stationary matrix 210, a second duct pairing (e.g., the duct pairing represented by duct portion 256) is aligned with a second one-third 234A of the stationary matrix 210 and a third duct pairing (e.g., the duct pairing represented by duct portion 259) is aligned with a last/third one-third 234B of the stationary matrix 210. Again, the various duct pairings may move through the thirds of the stationary matrix 210 in any manner (e.g., in or out of synchronization), but such positioning may ensure that adsorbent elements 212 in the stationary matrix 210 have a maximum amount of time to adsorb a target substance between exposures to a desorbing flow emanating from a duct pairing.

However, FIGS. 10 and 11 are merely two examples, and other embodiments may have any number of duct pairings arranged in any arrangement (e.g., four duct pairings arranged in different quadrants or not arranged in different quadrants). Regardless of the number and arrangement of duct pairings, the duct pairings do not necessarily need to be driven by the same drive system or be structurally linked together. In fact, the duct pairings could be entirely unconnected but configured to move such that the duct pairings remain positioned to enable a sufficient amount of adsorption between exposures to a desorbing flow, such as the positionings illustrated in FIGS. 10 and 11 (e.g., via a system of sensors, one or more controllers, etc.).

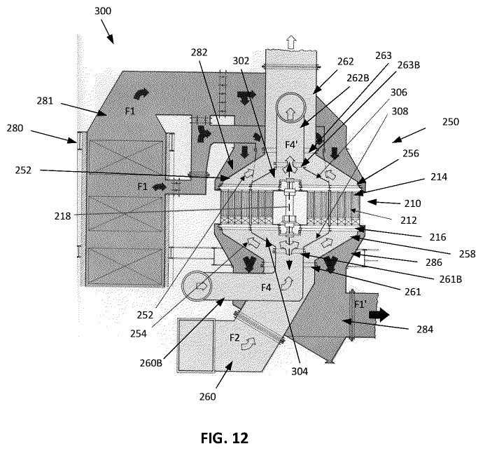

FIG. 12 illustrates yet another variation that may be applied to adsorption machine 200. In this variation, the adsorption machine 300 includes a movable duct system 250 with two separate ducting systems in addition to the stationary duct portions 260 and 262. An outer ducting system of the movable duct system 250 includes duct portions 252, 254, 256, and 258. An inner ducting system of the movable duct system 250 disposed interior of the outer duct system includes inner duct portions 302, 304, 306, and 308 that are connected to stationary duct portions 260B and 262B via rotational joints 261B and 263B. These components are largely similar to duct portions 252, 254, 256, and 258, stationary duct portions 260 and 262, and rotational joints 261 and 263, respectively, but may be operated separately. Such an arrangement might be useful, for example, if an outer circumferential portion of the stationary matrix 210 corresponding to the outer ducting system requires a different desorbing flow than an inner circumferential portion of the stationary matrix 210 corresponding to the inner ducting system. This is because, with the arrangement of FIG. 12, flows to each circumferential section/annulus may be controlled separately, e.g., to change characteristics (flow rate, pressure, temperature, etc.) of the desorbing flow (and/or a regenerative flow) and/or a rotational rate of ducts acting on that circumferential portion.

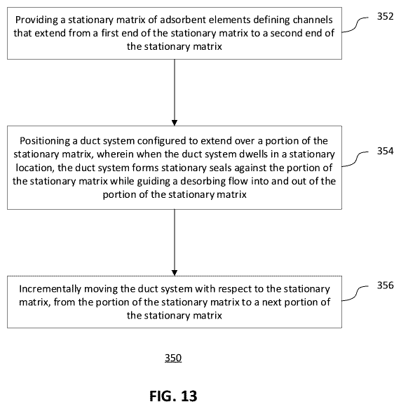

FIG. 13 is a flowchart of an example method for adsorption. At step 352, a stationary matrix of adsorbent elements is provided. The stationary matrix defines channels that extend from a first end of the stationary matrix to a second end of the stationary matrix. At step 354, a duct system is positioned to extend over a portion of the stationary matrix. When the duct system dwells in a stationary location, the duct system forms stationary seals against the portion of the stationary matrix while guiding a desorbing flow into and out of the portion of the stationary matrix. Then, at step 356, the duct system moves incrementally with respect to the stationary matrix, from the portion of the stationary matrix to a next portion of the stationary matrix. As mentioned above, in some embodiments, the stationary seals may be formed by expanding expandable seals and/or by moving the movable duct system (so that the matrix and the ducts contact seals included on one or both of these structures). Thus, in some embodiments, seals forming the stationary seals are moved out of contact with the stationary matrix prior to an incremental movement and are moved into contact with the stationary matrix subsequent to the incremental movement.

Overall, the adsorption machine achieves at least the advantages described herein. However, to be clear, while the application utilizes specific embodiments to describe the adsorption machine, as well as the advantages thereof, it is not intended to be limited to the details shown. Instead, it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the adsorption machine described herein, or portions thereof may be fabricated from any suitable material or combination of materials, such as metals or synthetic materials including, but not limited to, plastic, rubber, derivatives thereof, and combinations thereof. It is also intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

1. An adsorption machine comprising:
a stationary matrix of adsorbent elements defining channels that extend from a first end of the stationary matrix to a second end of the stationary matrix; and
a movable duct system including a first duct portion positioned adjacent the first end of the stationary matrix and a second duct portion positioned adjacent the second end of the stationary matrix, the first duct portion and the second duct portion being configured to move in synchronization with respect to the stationary matrix so that the first duct portion can guide a desorbing flow into the stationary matrix and the second duct portion can guide the desorbing flow, together with any substances desorbed from the stationary matrix, away from the stationary matrix.

2. The adsorption machine of claim 1, wherein the stationary matrix is cylindrically shaped and the first duct portion and the second duct portion are substantially sector shaped.

3. The adsorption machine of claim 2, wherein the movable duct system is rotatable about a central axis of the stationary matrix, the central axis being parallel to a direction in which the channels extend.

4. The adsorption machine of claim 1, wherein the movable duct system further comprises:
a third duct portion positioned adjacent the first end of the stationary matrix; and
a fourth duct portion positioned adjacent the second end of the stationary matrix, wherein the third duct portion and the fourth duct portion are configured to move in synchronization with respect to the stationary matrix so that the third duct portion can guide a portion of the desorbing flow into the stationary matrix and the fourth duct portion can guide the portion of the desorbing flow, together with any substances desorbed from the stationary matrix, away from the stationary matrix.

5. The adsorption machine of claim 4, wherein the third duct portion and the fourth duct portion extend oppositely from the first duct portion and the second duct portion, respectively, so that the third duct portion and the fourth duct portion are disposed across a first half of the stationary matrix when the first duct portion and the second duct portion are disposed across a second half of the stationary matrix.

6. The adsorption machine of claim 4, wherein the movable duct system further comprises:
a fifth duct portion positioned adjacent the first end of the stationary matrix; and
a sixth duct portion positioned adjacent the second end of the stationary matrix, wherein the fifth duct portion and the sixth duct portion are configured to move in synchronization with respect to the stationary matrix so that the fifth duct portion can guide an additional portion of the desorbing flow into the stationary matrix and the sixth duct portion can guide the additional portion of the desorbing flow, together with any substances desorbed from the stationary matrix, away from the stationary matrix.

7. The adsorption machine of claim 6, wherein the fifth duct portion and the sixth duct portion are positioned to extend across a first one-third of the stationary matrix when the first duct portion and the second duct portion are disposed across a second one-third of the stationary matrix and the third duct portion and the fourth duct portion are disposed across a third one- third of the stationary matrix.

8. The adsorption machine of claim 1, wherein the first duct portion and the second duct portion each include a leading section and a trailing section, wherein the leading section guides the desorbing flow into and out of the stationary matrix and the trailing section guides a regenerative flow into and out of the stationary matrix.

9. The adsorption machine of claim 8, wherein the desorbing flow is steam and the regenerative flow is conditioning air.

10. The adsorption machine of claim 1, wherein the movable duct system moves incrementally with respect to the stationary matrix.

11. The adsorption machine of claim 10, wherein incremental movements are indexed to move the first duct portion and the second duct portion from a first portion of the stationary matrix to a second portion of the stationary matrix that is adjacent to, but non-overlapping with, the first portion of the stationary matrix.

12. The adsorption machine of claim 11, wherein the stationary matrix is cylindrically shaped and subdivided into sector portions, including the first portion and the second portion, of equal sizes, and wherein the first duct portion and the second duct portion are sector-shaped and sized to match the sector portions of the stationary matrix.

13. The adsorption machine of claim 1, wherein the movable duct system dwells in a stationary location between incremental movements so that the first duct portion and the second duct portion can form stationary seals against the stationary matrix.

14. The adsorption machine of claim 13, wherein one or both of the stationary matrix and the first duct portion and the second duct portion includes expandable seals that expand into contact with the stationary matrix to form the stationary seals during dwell periods.

15. The adsorption machine of claim 13, wherein the first duct portion and the second duct portion move into contact with the stationary matrix to form the stationary seals during dwell periods.

16. An adsorption machine comprising:
a stationary matrix of adsorbent elements defining channels that extend from a first end of the stationary matrix to a second end of the stationary matrix; and
a movable duct system configured to move incrementally with respect to the stationary matrix, wherein the movable duct system dwells in a stationary location between incremental movements so that the movable duct system can form stationary seals against a particular portion of the stationary matrix while guiding a desorbing flow into and out of the particular portion of the stationary matrix.

17. The adsorption machine of claim 16, wherein the movable duct system moves into contact with the stationary matrix to form the stationary seals during dwell periods.

18. The adsorption machine of claim 16, wherein one or both of the movable duct system and the stationary matrix includes expandable seals that expand into contact with the stationary matrix to form the stationary seals during dwell periods.

19. A method of adsorption, comprising:
providing a stationary matrix of adsorbent elements defining channels that extend from a first end of the stationary matrix to a second end of the stationary matrix;
positioning a duct system configured to extend over a portion of the stationary matrix, wherein when the duct system dwells in a stationary location, the duct system forms stationary seals against the portion of the stationary matrix while guiding a desorbing flow into and out of the portion of the stationary matrix; and
incrementally moving the duct system with respect to the stationary matrix, from the portion of the stationary matrix to a next portion of the stationary matrix.

20. The method of claim 19, further comprising:
moving seals forming the stationary seals out of contact with the stationary matrix prior to an incremental movement; and
moving the seals into contact with the stationary matrix subsequent to the incremental movement.
